(19) United States
(12) Patent Application Publication
(10) Pub. No.: US 2025/0125994 A1
(43) Pub. Date: Apr. 17, 2025

(54) REPORTING OF A CONFIGURATION FOR SIDELINK REFERENCE SIGNALS AND DOWNLINK REFERENCE SIGNALS

(71) Applicant: QUALCOMM Incorporated, San Diego, CA (US)

(72) Inventors: Ahmed ELSHAFIE, San Diego, CA (US); Wei YANG, San Diego, CA (US); Seyedkianoush HOSSEINI, San Diego, CA (US); Alexandros MANOLAKOS, Athens (GR); Yi HUANG, San Diego, CA (US)

(21) Appl. No.: 18/684,801

(22) PCT Filed: Sep. 21, 2022
(86) PCT No.: PCT/US2022/044166

§ 371 Date: Feb. 19, 2024

(30) Foreign Application Priority Data
Sep. 22, 2021 (GR) 20210100626

(51) Int. Cl. H04L 25/02; H04L 5/00

(52) U.S. Cl. CPC H04L 25/0202; H04L 5/0051

(57) ABSTRACT

A communication device receives, from another communication device, a set of transmissions over a sidelink shared channel, or over a downlink shared channel (1005). The communication device estimates a Doppler spread or a delay spread based on the received set of transmissions over the shared channel (1010). The communication device selects a reference signal configuration, from multiple reference signal configurations, based on the estimated Doppler spread or the estimated delay spread (1015). The reference signal is a DMRS, a PTRS and/or a TRS. Finally, the communication device transmits feedback indicating the selected reference signal configuration for a subsequent set of transmissions over the shared channel (1020).

### CROSS REFERENCE

The present Application is a 371 national stage filing of International PCT Application No. PCT/US2022/044166 by ELSHAFIE et al. entitled “REPORTING OF A CONFIGURATION FOR SIDELINK REFERENCE SIGNALS AND DOWNLINK REFERENCE SIGNALS,” filed Sep. 21, 2022; and claims priority to Greece patent application Ser. No. 20/210,100626 by ELSHAFIE et al., entitled “SIDELINK REFERENCE SIGNAL AND DOWNLINK REFERENCE SIGNAL CONFIGURATION REPORTING,” filed Sep. 22, 2021, each of which is assigned to the assignee hereof, and each of which is expressly incorporated by reference in its entirety herein.

### FIELD OF TECHNOLOGY

The following relates to wireless communications, including sidelink reference signal and downlink reference signal configuration reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support techniques for sidelink reference signal and downlink reference signal configuration reporting. Various aspects of the present disclosure relate to reporting a reference signal configuration. A communication device (e.g., a UE) may receive, from another communication device (e.g., a base station or another UE), a set of transmissions over a shared channel (e.g., a physical downlink shared channel (PDSCH), a sidelink shared channel (PSSCH)). The communication device may determine one or more parameters, such as a Doppler spread or a delay spread, based on the received set of transmissions over the shared channel. The communication device may select a reference signal configuration, from multiple reference signal configurations, based on determining the parameter (e.g., the Doppler spread or the delay spread). As a result, the communication device may transmit feedback indicating the selected reference signal configuration for a subsequent set of transmissions over the shared channel. The present disclosure includes features to promote higher reliability and lower latency wireless communications, among other benefits.

A method for wireless communication at a first device is described. The method may include receiving, from a second device, a set of transmissions over a shared channel, determining at least one of a Doppler spread or a delay spread based on the received set of transmissions over the shared channel, selecting a reference signal configuration from a set of multiple reference signal configurations based on determining at least one of the Doppler spread or the delay spread, and transmitting, to the second device, feedback indicating the selected reference signal configuration for a subsequent set of transmissions over the shared channel.

An apparatus for wireless communication at a first device is described. The apparatus may include a processor, memory coupled with the processor, and instructions stored in the memory. The instructions may be executable by the processor to cause the apparatus to receive, from a second device, a set of transmissions over a shared channel, determine at least one of a Doppler spread or a delay spread based on the received set of transmissions over the shared channel, select a reference signal configuration from a set of multiple reference signal configurations based on determining at least one of the Doppler spread or the delay spread, and transmit, to the second device, feedback indicating the selected reference signal configuration for a subsequent set of transmissions over the shared channel.

Another apparatus for wireless communication at a first device is described. The apparatus may include means for receiving, from a second device, a set of transmissions over a shared channel, means for determining at least one of a Doppler spread or a delay spread based on the received set of transmissions over the shared channel, means for selecting a reference signal configuration from a set of multiple reference signal configurations based on determining at least one of the Doppler spread or the delay spread, and means for transmitting, to the second device, feedback indicating the selected reference signal configuration for a subsequent set of transmissions over the shared channel.

A non-transitory computer-readable medium storing code for wireless communication at a first device is described. The code may include instructions executable by a processor to receive, from a second device, a set of transmissions over a shared channel, determine at least one of a Doppler spread or a delay spread based on the received set of transmissions over the shared channel, select a reference signal configuration from a set of multiple reference signal configurations based on determining at least one of the Doppler spread or the delay spread, and transmit, to the second device, feedback indicating the selected reference signal configuration for a subsequent set of transmissions over the shared channel.

In some examples of the method, apparatuses, and non-transitory computer-readable medium described herein, receiving the set of transmissions may include operations, features, means, or instructions for receiving, from the second device, one or more sidelink transmissions over a sidelink shared channel and where selecting the reference signal configuration from the set of multiple reference signal configurations may be based on the received one or more sidelink transmissions over the sidelink shared channel.

In some examples of the method, apparatuses, and non-transitory computer-readable medium described herein, selecting the reference signal configuration from the set of multiple reference signal configurations may include operations, features, means, or instructions for selecting a demodulation reference signal (DMRS) pattern from a set of DMRS patterns based on determining at least one of the Doppler spread or the delay spread, where transmitting the feedback includes and transmitting, to the second device, an indication of the selected DMRS pattern.

In some examples of the method, apparatuses, and non-transitory computer-readable medium described herein, the indication includes a bitmap.

Some examples of the method, apparatuses, and non-transitory computer-readable medium described herein may further include operations, features, means, or instructions for determining a reference signal density associated with the received set of transmissions over the shared channel, the reference signal density including a sidelink phase tracking reference signal (PTRS) density in at least one of a time domain or a frequency domain, where transmitting the feedback includes and transmitting, to the second device, an indication of the sidelink PTRS density in at least one of the time domain or the frequency domain.

Some examples of the method, apparatuses, and non-transitory computer-readable medium described herein may further include operations, features, means, or instructions for determining at least one of a resource pool or a set of resource pools for the wireless communication based on the selected reference signal configuration, at least one of the resource pool or the set of resource pools corresponding to one or more of a DMRS pattern or a set of DMRS patterns, a sidelink shared channel allocation, a set of sidelink shared channel allocations, a sidelink PTRS configuration, or a set of sidelink PTRS configurations, where transmitting the feedback includes and transmitting, to the second device, an indication of at least one of the resource pool or the set of resource pools for the wireless communication.

In some examples of the method, apparatuses, and non-transitory computer-readable medium described herein, transmitting the feedback may include operations, features, means, or instructions for transmitting, to the second device, the feedback indicating the selected reference signal configuration in a medium access control-control element (MAC-CE).

In some examples of the method, apparatuses, and non-transitory computer-readable medium described herein, transmitting the feedback may include operations, features, means, or instructions for transmitting, to the second device, the feedback indicating the selected reference signal configuration over a sidelink feedback channel or a sidelink shared channel.

Some examples of the method, apparatuses, and non-transitory computer-readable medium described herein may further include operations, features, means, or instructions for receiving, from the second device, a control message including an indication to transmit the feedback indicating the selected reference signal configuration, the control message including a sidelink control information message and where transmitting the feedback indicating the selected reference signal configuration may be based on the received control message.

In some examples of the method, apparatuses, and non-transitory computer-readable medium described herein, receiving the set of transmissions may include operations, features, means, or instructions for receiving, from the second device, one or more downlink transmissions over a downlink shared channel, the method further including, estimating at least one of the Doppler spread or the delay spread based on the received one or more downlink transmissions over the downlink shared channel, and where selecting the reference signal configuration from the set of multiple reference signal configurations may be based on estimating at least one of the Doppler spread or the delay spread, the selected reference signal configuration indicating one or more of a reference signal type, a reference signal pattern, a set of antenna ports, or a reference signal satisfying a criterion.

Some examples of the method, apparatuses, and non-transitory computer-readable medium described herein may further include operations, features, means, or instructions for receiving, from the second device, a grant including a resource allocation based on transmitting a scheduling request for the resource allocation to transmit the feedback indicating the selected reference signal configuration, determining one or more resources to transmit the feedback indicating the selected reference signal configuration based on the resource allocation, where transmitting the feedback includes, and transmitting, to the second device, the feedback indicating the selected reference signal configuration using the one or more resources.

Some examples of the method, apparatuses, and non-transitory computer-readable medium described herein may further include operations, features, means, or instructions for multiplexing a first uplink channel associated with the feedback indicating the selected reference signal configuration and a second uplink channel associated with a hybrid automatic repeat request feedback, at least one of the first uplink channel or the second uplink channel including an uplink control channel or an uplink shared channel and where transmitting the feedback indicating the selected reference signal configuration may be based on the multiplexing.

Some examples of the method, apparatuses, and non-transitory computer-readable medium described herein may further include operations, features, means, or instructions for receiving control signaling including an indication of a criterion for transmitting the feedback indicating the selected reference signal configuration, the criterion indicating to transmit the feedback after receiving a number of transmissions of the set of transmissions, the control signaling including one or more of a radio resource control (RRC) message, a MAC-CE, or a downlink control information (DCI) and where transmitting the feedback indicating the selected reference signal configuration may be based on the received control signaling.

In some examples of the method, apparatuses, and non-transitory computer-readable medium described herein, the radio resource control message includes a semi-persistent scheduling configuration including the indication of the criterion for transmitting the feedback indicating the selected reference signal configuration.

Some examples of the method, apparatuses, and non-transitory computer-readable medium described herein may further include operations, features, means, or instructions for receiving, from the second device, control signaling indicating a mode of operation for transmitting reference signals, the mode of operation corresponding to one or more types of reference signals enabled, the one or more types of reference signals including one or more of DMRSs, tracking reference signals, or PTRSs.

Some examples of the method, apparatuses, and non-transitory computer-readable medium described herein may further include operations, features, means, or instructions for transmitting the feedback indicating the selected reference signal configuration may be based on the mode of operation.

In some examples of the method, apparatuses, and non-transitory computer-readable medium described herein, the feedback includes at least one of an indication to enable a reference signal or adjust a reference signal density in at least one of a time domain associated with the reference signal or a frequency domain associated with the reference signal.

### BRIEF DESCRIPTION OF THE DRAWINGS

FIGS. 1 and 2 each illustrate an example of a wireless communications system that supports sidelink reference signal and downlink reference signal configuration reporting in accordance with aspects of the present disclosure.

FIG. 3 illustrates an example of a reference signal configuration set that supports sidelink reference signal and downlink reference signal configuration reporting in accordance with aspects of the present disclosure.

FIGS. 4 and 5 each illustrate an example of a process flow that supports sidelink reference signal and downlink reference signal configuration reporting in accordance with aspects of the present disclosure.

FIGS. 6 and 7 show block diagrams of devices that support sidelink reference signal and downlink reference signal configuration reporting in accordance with aspects of the present disclosure.

FIG. 8 shows a block diagram of a communications manager that supports sidelink reference signal and downlink reference signal configuration reporting in accordance with aspects of the present disclosure.

FIG. 9 shows a diagram of a system including a device that supports sidelink reference signal and downlink reference signal configuration reporting in accordance with aspects of the present disclosure.

FIGS. 10 through 12 show flowcharts illustrating methods that support sidelink reference signal and downlink reference signal configuration reporting in accordance with aspects of the present disclosure.

### DETAILED DESCRIPTION

A communication device (e.g., a receiving device) may perform channel estimation to improve communication reliability in a wireless communication system. For example, a receiving device may use one or more reference signals transmitted from another communication device (e.g., a transmitting device) to estimate characteristics of a channel for demodulation and decoding of wireless communications. In some cases, reference signals may be transmitted according to a reference signal pattern, which may correspond to a density and location (e.g., in a time-domain or a frequency-domain) of reference signals within a transmission time interval (TTI). In such cases, the reference signal pattern may be used to improve channel estimation at the receiving device. In some examples, the reference signal pattern may be determined by the transmitting device. However, interference and other channel characteristics observed by the receiving device may not be known to the transmitting device so the transmitting device's determination may not be accurate. Therefore, it may be desirable to enable mechanisms for the receiving device to communicate, to the transmitting device, a suitable configuration for transmitting reference signals that may account for changing channel conditions, such as changes in interference.

Various aspects of the present disclosure relate to enabling a communication device to support reporting for one or more configuration, such as sidelink and downlink reference signal configurations. For example, the communication device may use signals transmitted over one or more shared channels (e.g., a PDSCH or a PSSCH) to estimate one or more channel parameters, such as how frequent the channel changes, the Doppler spread, or the delay spread. In some examples, the estimated channel parameters may be used by the receiving device to determine a suitable configuration for reference signal transmissions. The configuration may correspond to a density of reference signal transmissions with respect to the time-domain and the frequency-domain (e.g., may correspond to a time-frequency density). The communication device may report feedback indicating the determined configuration, or aspects related to the determined configuration, among other information, to the transmitting device.

In some examples, for sidelink communications, the determined configuration may correspond to a pattern for transmitting demodulation reference signals (DMRSs), a resource pool associated with multiple DMRS patterns, a time-density for transmitting phase tracking reference signals (PTRSs), or a frequency-density for transmitting PTRSs. In some other examples, for downlink communications, the determined configuration may correspond to a DMRS pattern, a type of DMRSs (e.g., type 1 or type 2), a number of ports for transmitting reference signals, or a reference signal type (e.g., DMRS, PTRS, or tracking reference signals (TRS)). Enabling the communication device to report feedback indicating a suitable configuration for transmitting reference signals may improve channel estimation at the communication device and, accordingly, improve throughput and reduce latency for the communication device, among other benefits.

Aspects of the disclosure are initially described in the context of wireless communications systems. Aspects of the disclosure are also described in the context of a reference signal configuration set and process flows. Aspects of the disclosure are further illustrated by and described with reference to apparatus diagrams, system diagrams, and flowcharts that relate to sidelink reference signal and downlink reference signal configuration reporting.

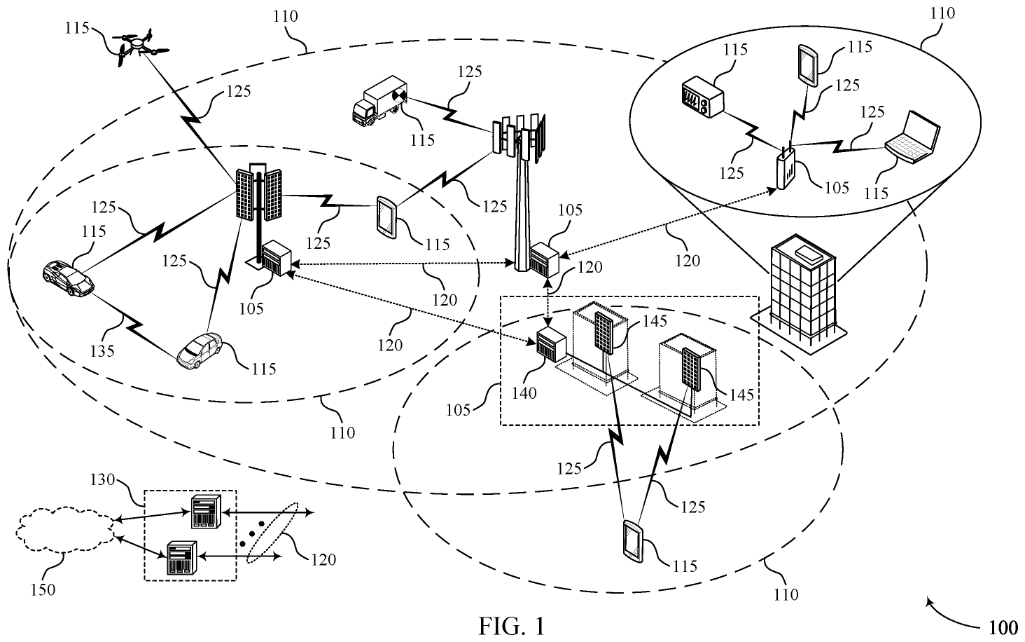

FIG. 1 illustrates an example of a wireless communications system 100 that supports sidelink reference signal and downlink reference signal configuration reporting in accordance with aspects of the present disclosure. The wireless communications system 100 may include one or more base stations 105, one or more UEs 115, and a core network 130. In some examples, the wireless communications system 100 may be an LTE network, an LTE-Advanced (LTE-A) network, an LTE-A Pro network, or an NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In the wireless communication system 100, a communication device may use signals transmitted over a shared channel (e.g., a PDSCH or a PSSCH, or both) to estimate one or more channel parameters, such as how frequent the channel changes, the Doppler spread, or the delay spread. For example, a UE 115 may estimate channel parameters to determine a suitable configuration for reference signal transmissions. The configuration may correspond to a density of reference signal transmissions with respect to the time-domain and the frequency-domain (e.g., may correspond to a time-frequency density). The UE 115 may report feedback indicating the determined configuration, or aspects related to the determined configuration, to another communication device (e.g., a base station 105 or a relay UE 115). By enabling the UE 115 to report feedback indicating a suitable configuration for transmitting reference signals may improve channel estimation at the UE 115, as well as improve throughput and reduce latency for the UE 115.

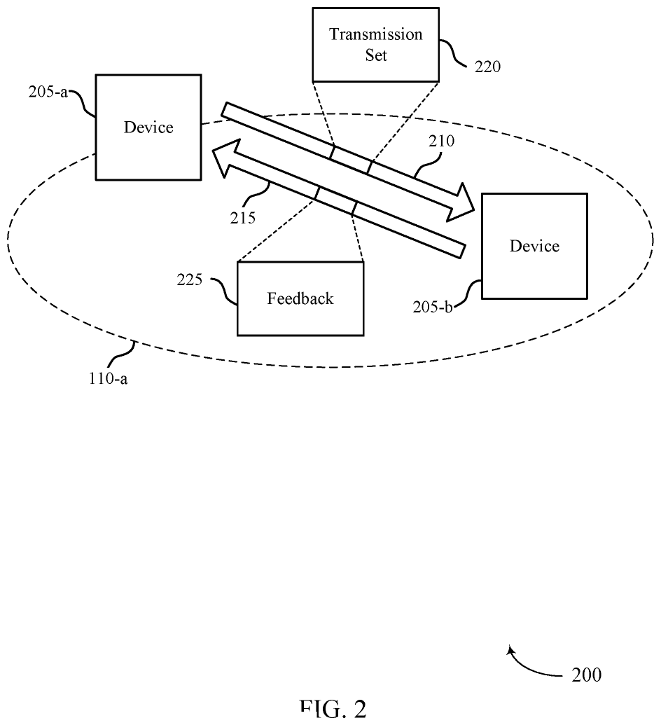

FIG. 2 illustrates an example of a wireless communications system 200 that supports sidelink reference signal and downlink reference signal configuration reporting in accordance with aspects of the present disclosure. The wireless communications system 200 may implement or be implemented by one or more aspects of the wireless communications system 100. For example, the wireless communications system 200 may include a device 205-a and a device 205-b, which may be examples of devices as discussed with reference to FIG. 1. In the example of FIG. 2, the device 205-a may be a transmitting device (e.g., a base station 105 or a UE 115), while the device 205-b may be a receiving device (e.g., a UE 115). The device 205-a and the device 205-b may support wired or wireless communications within a geographic coverage area 110-a, which may be an example of a geographic coverage area 110 described with reference to FIG. 1. The wireless communication system 200 illustrates communications between the device 205-a and the device 205-b. For example, the device 205-a and the device 205-b may communicate over the communication link 210 (e.g., a sidelink or a downlink) and the communication link 215 (e.g., a sidelink or an uplink).

In some examples of the wireless communication system 200, the device 205-amay transmit one or more reference signals to the device 205-b for channel estimation. For example, the device 205-b may use the one or reference signals to estimate characteristics of a channel for demodulation and decoding of wireless communications. The device 205-a may transmit the one or more reference signals according to a configuration, also be referred to as a pattern, determined by the device 205-a. However, channel characteristics (e.g., interference, among other examples) observed by the device 205-b may not be known to the device 205-a. Therefore, in some cases, the device 205-b may indicate, to the device 205-a, a suitable (e.g., appropriate) configuration, or aspects of a suitable configuration, for transmitting downlink (e.g., or sidelink) reference signals to the device 205-b. In some cases, such an indication may enable the device 205-a to determine a desirable configuration for the device 205-b, such that that the reliability of the downlink (e.g., or sidelink) communications may be improved. For example, based on signals transmitted over a shared channel (e.g., data signals), the device 205-b may determine one or more aspects (e.g., information) of a suitable configuration of reference signals (e.g., enabled reference signals), such as PTRS, TRS, and DMRS. The device 205-b may then report such information to the device 205-a, for example as feedback.

In the case of sidelink, the device 205-b may report information regarding a suitable configuration in a physical sidelink feedback channel (PSFCH), in a MAC-CE, or in a physical sidelink shared channel (PSSCH) after decoding one or more signals transmitted over a PSSCH. In the case of uplink (e.g., a Uu link), the device 205-b may report information regarding a suitable configuration in a physical uplink control channel (PUCCH), a physical uplink shared channel (PUSCH) or a MAC-CE after decoding one or more signals transmitted over a PDSCH. That is, based on a receiving a PDSCH signal (e.g., or a set of PDSCH signals) or a PSSCH signal (e.g., or a set of PSSCH signals) transmitted by the device 205-a, the device 205-b may estimate the Doppler spread (e.g., the channel change rate in time-domain) and delay spread (e.g., the channel change rate in frequency domain) to determine a suitable configuration for reference signals to be transmitted in future transmissions (e.g., retransmissions). Then, based on the estimated channel parameters, the device 205-b may determine the time-frequency density (e.g., the density in the time domain and the frequency domain) of the future reference signals (e.g., DMRS, PTRS, or TRS signaling) that may be used (e.g., to estimate the channel) for future retransmissions or retransmission of a PDSCH signal.

Delay spread, for example, may be the maximum path delay (e.g., between the device 205-a and the device 205-b). In some cases, delay spread may be determined based on the coherence bandwidth (e.g., a frequency property) where the channel, over the coherence bandwidth, may be approximately fixed (e.g., constant). Doppler shift, for example, may be the frequency offset (e.g., error) or maximum separation (e.g., difference) of frequency offsets among paths (e.g., between the device 205-a and the device 205-b). That is, a frequency property may be used (e.g., by the device 205-b) to determine a coherence time, for example where the channel remains approximately constant. Thus, the signal density (e.g., a DMRS density, a PTRS density, or a TRS density) in the time-domain (e.g., the number of DMRS, PTRS, or TRS symbols and the locations of such symbols) may be related to the Doppler spread. For example, if the channel has a reduced Doppler spread, a single DMRS symbol, and a reduced TRS time-domain density, the signal density may be suitable to use during a time within a slot duration. The signal density (e.g., a DMRS density, a PTRS density, or a TRS density) in the frequency-domain may be related to the delay spread. For example, if the delay spread increases, an increased number of frequency-domain tones may be desirable. In some cases, for example in the case of DMRS, the frequency-density may be determined by the DMRS configuration type (e.g., type 1 or type 2).

As illustrated in the example of FIG. 2, the device 205-b may receive reference signals according to a configuration. For example, the device 205-b may receive, from the device 205-a, a set of transmissions (e.g., a transmission set 220) over a shared channel. The transmission set 220 may include one or more reference signals, which may be sidelink reference signals or downlink references signals. The device 205-b may determine a Doppler spread or a delay spread based on the received set of transmissions over the shared channel. The device 205-b may select a reference signal configuration, from multiple reference signal configurations, based on determining the Doppler spread or the delay spread. The device 205-b may transmit, to the device 205-a, feedback (e.g., feedback 225) indicating the selected reference signal configuration for a subsequent set of transmissions over the shared channel. By enabling the device 205-b to report feedback indicating a suitable configuration for reference signaling may improve channel estimation at the device 205-b and, accordingly, improve throughput and reduce latency for one or both of the device 205-a or the device 205-b.

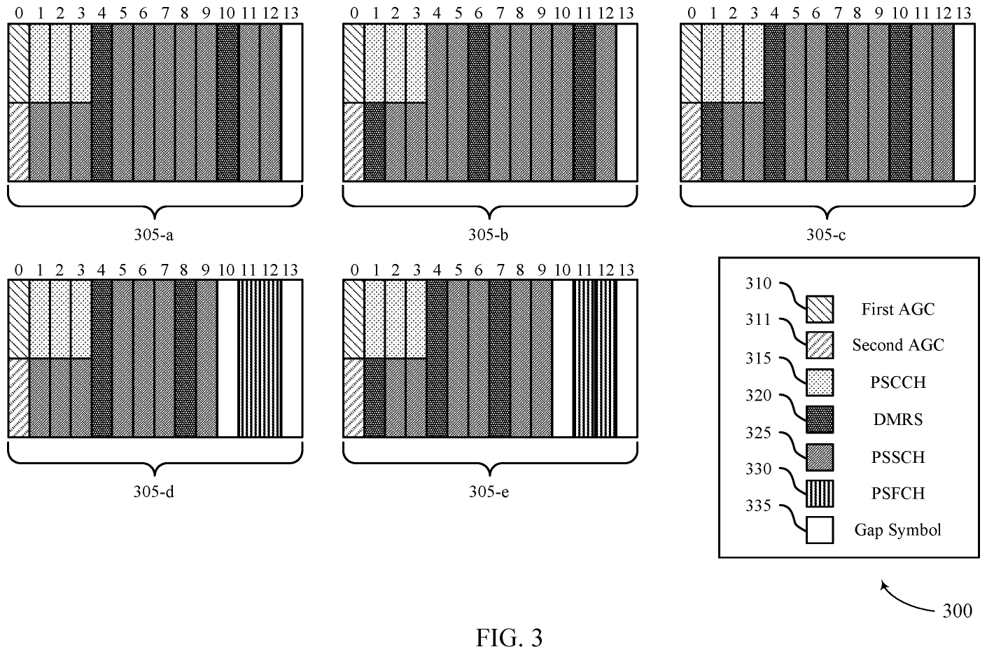

FIG. 3 illustrates an example of a reference signal configuration set 300 that supports sidelink reference signal and downlink reference signal configuration reporting in accordance with aspects of the present disclosure. The reference signal configuration set 300 may implement aspects of the wireless communication system 100 and the wireless communication system 200. For example, aspects of the reference signal configuration set 300 may be implemented at, or implemented by, one or both of a base station or a UE, which may be examples of devices discussed with reference to FIGS. 1 and 2. The reference signal configuration set 300 illustrates example configurations, also referred to as patterns, which may be used by a communication device (e.g., a transmitting device) to transmit one or more reference signals.

A transmitting device may transmit one or more reference signals, which may be used by a receiving device to perform channel estimation. As described herein, a receiving device may be an example of a UE 115 and a transmitting device may be an example of a base station 105 or a UE 115 as described throughout the present disclosure, including with reference to FIGS. 1 and 2. In some cases, the transmitting device may determine a configuration for transmitting reference signals to a receiving device. For example, in the case of downlink, a transmitting device may indicate a configuration for transmitting DMRSs. For example, the transmitting device may indicate a pattern for transmitting DMRSs (e.g., a DMRS pattern) to the receiving device via control signaling (e.g., a downlink control information (DCI)). In some cases, the DMRS patterns may be defined in a table (e.g., a DMRS table). In such cases, the transmitting device may transmit control signaling (e.g., a radio resource control (RRC) message) indicating a table index associated with a DMRS pattern defined in the DMRS table.

A DMRS configuration (e.g., a semi-static configuration) may be associated with the number of ports (e.g., quasi co-located ports) that the DMRSs are transmitted. For example, DMRSs may be transmitting according to a DMRS pattern, which may be associated with a number of ports used to transmit the DMRSs. In some examples (e.g., for type-1 DMRS patterns), 31 different DMRS patterns may each be used to transmit DMRSs with up to 8 antenna ports. In some cases, the number of DMRS ports may be configured according to a DMRS port table. Additionally or alternatively, there may be no physical resource block group alignment across devices receiving the transmitted DMRSs (e.g., across one or more receiving devices). In some other examples (e.g., for type-2 DMRS patterns), 58 different patterns may each be used to transmit DMRSs with up to up to 12 ports. In some cases, the DMRSs may be transmitted according to a front-loaded (e.g., single front-loaded or double front-loaded) DMRS pattern. The number of repetitions in a DMRS pattern may be associated with the format of the slot. For example, in some cases (e.g., for type-A mapping) a repetition of up to 4 DMRSs may be associated with slot formats that are 14 symbols in duration. In another example, (e.g., in the case of type-B mapping), a repetition of up to 2 DMRSs may be associated with slot formats that are 2, 4, 6, or 7 symbols in duration.

The DMRSs may be transmitted according to different modulation schemes. For example, in the case of sidelink, one and two layer DMRS transmissions may be supported with QPSK, 16-QAM, 64-QAM, and 256-QAM. In some cases, a single code division multiplexing group may be supported. Additionally or alternatively, the precoding matrix for the channel (e.g., the PSSCH) may be an identity matrix. The DMRSs may be transmitted with different patterns. For example, a DMRS pattern including repetitions of 2, 3, and 4 symbols (e.g., within a slot) may be configured (e.g., preconfigured) for use by the transmitting device. A DMRS pattern may be associated with a slot duration of 12 symbols or 6 symbols, among other examples. The transmitting device may select a DMRS pattern (e.g., according to channel conditions) and signal an indication of the selected pattern to the receiving device, for example in a sidelink control information ((SCI), for example an SCI-1). In some cases, the DMRS pattern may be selected from a number of patterns (e.g., Nₚₐₜₜₑᵣₙ) configured by higher layer parameters, such as the instruction element (IE) sl-PSSCH-DMRS-TimePatternList. In some cases, the IE TimePatternList may be associated with a resource pool where up to three patterns (e.g., Nₚₐₜₜₑᵣₙ=3) may be configured.

As illustrated in the example of FIG. 3, DMRS patterns 305 (e.g., DMRS pattern 305-a, DMRS pattern 305-b, DMRS pattern 305-c, DMRS pattern 305-d, and/or DMRS patten 305-e) may be transmitted using different slot formats. The slot format available for transmitting communications (e.g., sidelink communications) may include 14 symbols (e.g., symbols 0 through 13). For example, the slot format may include one or more DMRSs 320, one or more physical sidelink control channels (PSCCHs), such as one or more PSCCHs 315 (e.g., carrying SCI-1), one or more PSSCHs 325 (e.g., carrying SCI-2 or other sidelink data messages), one or more PSFCHs 330 (e.g., carrying feedback) and one or more gap symbols 335. Additionally, the slot format may also include a first symbol portion, which may be an automatic gain control (AGC) symbol that may be a copy of the following symbol. For example, a DMRS pattern 305-a may be transmitted in a slot format that includes a first AGC 310 that may be a copy of the PSCCH 315 in symbol 1 and a second AGC 311 that may be a copy of the PSSCH 325 in symbol 1.

The transmitting device may also transmit one or more PTRSs according to a configuration. In some examples, PTRSs may be used to track the phase of the local oscillator at the transmitting device (e.g., and the receiving device) to reduce the effects of oscillator phase noise on the communications, among other examples. In some cases, PTRS may be transmitted over (e.g., embedded into) the PDSCH or PUSCH. For example, in the case of single user MIMO (SU-MIMO), the transmitting device may use orthogonal multiplexing to transmit PTRSs and data to the receiving device. In another example, (e.g., in the case of multi-user MIMO (MU-MIMO)), the transmitting device may use non-orthogonal multiplexing to transmit PTRSs to the receiving device. In some cases, PTRSs may be transmitted according to a default configuration where the PTRSs are distributed in the frequency-domain (e.g., may occur on non-consecutive subcarriers). In some cases, resource blocks including PTRSs may be derived from scheduled resource blocks and the associated frequency-density. For example, a single PTRS port may be mapped on a subcarrier carrying one or more DMRS ports of the associated DMRS port group. In the case of non-consecutive scheduling, resource blocks may be indexed such that resource blocks containing PTRSs may be identified by the receiving device. In some examples, if one or more resource elements occupied by a PTRS overlaps with one or more resource elements occupied by a CSI-RS, the overlapping PTRS resource elements may be punctured. In some examples, if one or more resource elements occupied by a PTRS overlaps with one or more resource elements occupied by an SRS, the overlapping PTRS resource elements may be punctured.

In some examples, the time-density of PTRSs may be associated with a modulation and coding scheme (MCS). Additionally or alternatively, the frequency-density of PTRSs may be associated with a scheduled bandwidth (e.g., a contiguous scheduled bandwidth). In some cases, the time-density for PTRSs may indicate that a PTRS may be repeated in each symbol, each second symbol, or each fourth symbol. The frequency-density for PTRSs may indicate that a PTRS may occupy a single subcarrier in each resource block, each second resource block, or each fourth resource block. In some cases, the density (e.g., the time-density or frequency-density) of PTRSs may be associated with one or more density tables configured by the transmitting device (e.g., via an RRC message). For example, if a PTRS is present (e.g., received), a PTRS port may be present in each OFDM symbol and each second resource block. In some cases, an RRC may be used to configure one or more thresholds associated with the one or more density tables. For example, a receiving device may be configured with one or more sets of thresholds (e.g., per bandwidth part) using dedicated RRC signaling. In some cases, the receiving device may report a suitable MCS or a bandwidth threshold based on phase noise characteristics at the receiving device and, in some cases, an MCS table with the maximum modulation order the receiving device may support.

In some cases, the number of antenna ports for transmitting DMRSs may be configured via control signaling (e.g., a DCI). For example, if two downlink DMRS port groups are transmitted, each DMRS port group may be associated with one PTRS port and one continuous wave transmission, respectively. In some cases, for example if both ports are active, the time-density of the PTRS port corresponding to the continuous wave transmission with a relatively lower MCS (e.g., relative to the other PTRS port) may be the same as the time-density of the PTRS port corresponding to continuous wave with the relatively higher MCS. In another case, for example if one PTRS port is configured for a DMRS port group for two continuous wave transmissions, the PTRS port may be associated with the lowest DMRS port index among the DMRS ports assigned for the continuous wave transmission with higher MCS. In yet another example, if one PTRS port is transmitted and the scheduled DMRS ports are from two DMRS port groups, the receiving device may utilize the PTRS port for phase tracking for PDSCH layers corresponding to DMRS ports in the two DMRS port groups (i.e., the PTRS port is shared among the two DMRS port groups). In some cases, the number of downlink PTRS ports may be configured via higher layer signaling. In some cases (e.g., for mini-slot transmissions), the receiving device may signal a suitable number of PTRS ports according the capabilities of the receiving device. In some cases, control signaling (e.g., RRC or DCI) may be used to indicate an association between one or more PTRS ports and one or more DMRS ports. In some cases, a PTRS port index may be used for non-codebook based uplink transmissions and higher layer parameters may be used for codebook-based uplink transmissions.

In some cases, if a PTRS is present (e.g., received), a PTRS mapping pattern may start in the first symbol containing a PDSCH or (e.g., or a PUSCH) in the slot. The PTRSs may then be mapped according to a periodicity, for example may be repeated in each L_{PT-RS} symbol. In some cases, the PTRS mapping pattern may restart at each symbol containing a DMRS. In such cases, the PTRSs may then be mapped to every L_{PT-RS} symbol relative to the symbol that the PTRS mapping restarted. In the case of two adjacent (e.g., consecutive) DMRS symbols, the PTRS pattern may restart with the second of the two consecutive DMRS symbols as a reference. As a result, when the PTRS time-density is less than one, the symbol subsequent to the front-loaded DMRS, and the symbol subsequent to additional DMRS (e.g., if subsequent DMRSs occur) may not contain a PTRS. In some cases, a PTRS mapping pattern may indicate that a PTRS may not be transmitted in OFDM symbols that may contain PDSCH, PUSCH, or DMRS transmissions. Additionally or alternatively, a PTRS may not be transmitted in resource elements that may overlap with a configured CORESET.

For uplink cyclic prefix OFDM (CP-OFDM) with intra-slot frequency hopping, before applying a frequency domain orthogonal cover code (FD-OCC) for each hop on a subcarrier where a PTRS is mapped, the PTRS symbols in the hop may be obtained by repeating the first front-loaded DMRS symbol on the same subcarrier of the hop where the DMRS symbol occurs. In some cases, the subcarrier in a resource block that the PTRS is mapped may be used to determine associated DMRS ports. In some cases, after determining the subcarrier that the PTRS is mapped (e.g., and before applying the FD-OCC), the receiving device may support repeating the modulated sequence symbol on the associated first front-loaded symbol of a DMRS port of the subcarrier for which the PTRS is mapped. In some cases, a downlink PTRS port and one or more downlink DMRS ports (e.g., within the associated downlink DMRS port group) may be quasi co-located with respect to delay spread, Doppler spread, Doppler shift, average delay, or spatial Rx parameters. In some cases, if a downlink PTRS port is transmitted for two scheduled downlink DMRS port groups, the PTRS port and the one or more DMRS ports (e.g., which may not be in the associated DMRS port group) may be quasi co-located with respect to delay spread, Doppler spread or Doppler shift.

In some cases, if a single uplink PTRS port is transmitted (e.g., via PUSCH) the PTRS power ratio per layer per may correspond to a parameter, A, where A may be configured (e.g., via an RRC parameter through an IE such as the UL-PTRS-EPRE-ratio IE) according to a table. In some other cases, if more than one PTRS port is configured, the transmit port for symbols with (e.g., or without) PTRS may be the same. Additionally or alternatively, the PDSCH to PTRS energy per resource element (EPRE) ratio per layer may be described by the following equation: −10×log₁₀(NPTRS)−A, where A may be configured (e.g., via an RRC parameter through an IE such as the DL-PTRS-EPRE-ratio IE) according to a table.

In some cases, uplink PTRS for a DFT-s-OFDM waveform may be supported. For example, the presence (e.g., or absence) of a PTRS for a DFT-s-OFDM waveform may be configured via control signaling (e.g., via an RRC through the UL-PTRS-present-transform-precoding IE). In some cases, multiple patterns (e.g., densities) of PTRSs for DFT-s-OFDM waveforms may be supported. In some cases, a DFT PTRS insertion for uplink DFT-S-OFDM may be in the form of multiple portions (e.g., chunks) per symbol. In some cases, a chunk size (K) may be 2 or 4 symbols (e.g., based on the MCS or bandwidth). In some cases, the supported number of chunks per DFT-OFDM symbol (X) may be 2, 4, or 8. In some cases, X may depend on the allocated bandwidth, the MCS, or the value of K. The time-domain PTRS density may be configured by an RRC parameter, for example the UL-PTRS-time-density-transform-precoding IE. In some cases (e.g., if K=2), the samples in DFT domain may be divided into X intervals, and the chunks may be located in the middle of each interval. In some other cases (e.g., if K=4), the samples in DFT domain may be divided in X intervals, where in the first interval the chunk may be placed in the first K samples and in the last interval the chunk may be placed in the last K samples. In the remaining intervals, the chunk may be placed in a symbol that may occur between the first and the last interval. In some cases, an RRC parameter (e.g., the UL-PTRS-frequency-density-transform-precoding IE) may be used to indicate a set of thresholds, for example T={NRBn, n=0, 1, 2, 3, 4}, per BWP. In such cases, the RRC parameter may indicate the values of X and K that may be used by the receiving device based on the scheduled bandwidth of the PTRS.

In some examples (e.g., if pi/2 binary phase shift keying (BPSK) modulation is used), a single sequence may be generated (e.g., for a given slot) for the first DFT-s-OFDM symbol containing a PTRS in the slot and may be repeated for every DFT-s-OFDM symbol containing a PTRS in the slot. In some cases, the sequence may be inserted in the m^{th} position (e.g., where 0≤m≤(M−1)) before transform precoding (e.g., a size M sequence). In some cases, a BPSK sequence may be generated such that the pseudo random sequence may be initialized with a same formula that may have been used for PDSCH DMRSs, for example with the nDMRS-CSH-Identity-Transform-precoding IE indicating the scrambling identifier. In some cases, the modulation may depend on the DFT position (e.g., m) of the PTRS sample. In some cases, the orthogonal cover code (OCC) may be applied to the BPSK sequence before the modulation.

The transmitting device may also transmit one or more TRSs according to a configuration. In some cases, TRS may improve time and frequency tracking capability of a communication device. In some cases, TRSs may be configured as a CSI-RS resource set. In some examples, TRS may support a single port. In some instances, a receiving device may be configured with multiple TRS for multi-TRP or multi-panel transmissions. In some cases, TRSs have be transmitted with equal resource element spacing (e.g., in the frequency-domain) within a TRS bandwidth. In some cases, DMRSs may be time-division multiplex with TRSs. In some cases, TRS may be configured on a carrier or on an active BWP, for example if a synchronization signal block (SSB) may not present. In some cases, TRS can be quasi co-located with PDSCH DMRS, for example with respect to delay spread, average delay, Doppler shift, and Doppler spread. In some cases, a TRS sequence may be based on pseudo-random generator.

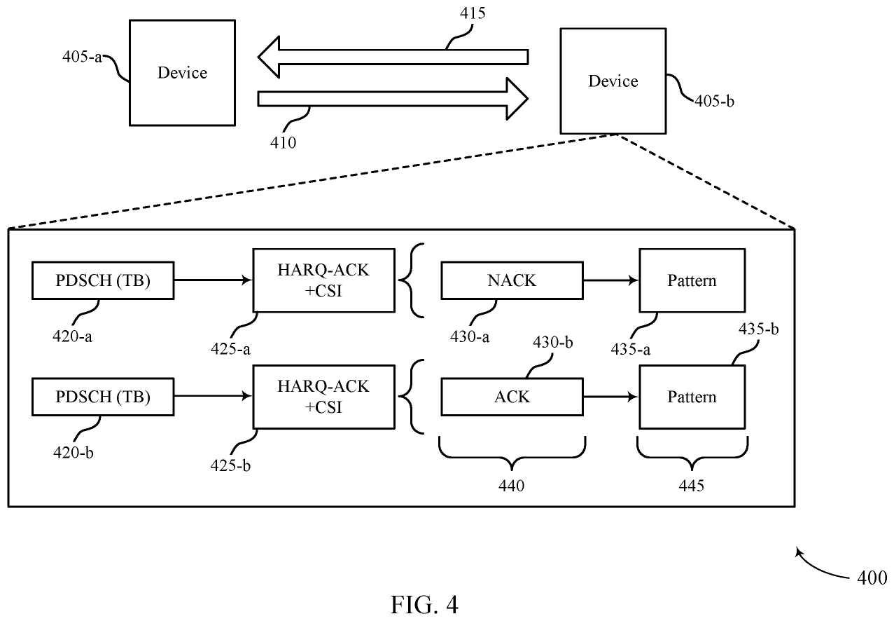

FIG. 4 illustrates an example of a process flow 400 that supports sidelink reference signal and downlink reference signal configuration reporting in accordance with aspects of the present disclosure. The process flow 400 may implement or be implemented by one or more aspects of the wireless communications system 100 and the wireless communications system 200. For example, the process flow 400 may include a device 405-a and a device 405-b, which may be examples of devices as discussed with reference to FIG. 1. In the example of FIG. 4, the device 405-a may be a transmitting device (e.g., a base station 105), while the device 405-b may be a receiving device (e.g., a UE 115). The process flow 400 illustrates communications between the device 405-a and the device 405-b. For example, the device 405-a and the device 405-b may communicate over the communication link 410 (e.g., a downlink) and the communication link 415 (e.g., a sidelink).

In some examples, the device 405-b may transmit a request for the device 405-a to send a configuration for transmitting reference signals. In response, the device 405-a may indicate one or more resources (e.g., PUCCH or PUSCH resources) that the device 405-b may transmit an indication of a suitable configuration for transmitting reference signals (e.g., as feedback). In some examples, the device 405-b (e.g., and the device 405-a) may be configured such that the feedback indicating a suitable configuration for transmitting reference signals (e.g., downlink reference signals) may be transmitted, for example, after a number (X) of PDSCH transmissions. In another example, the device 405-b and the device 405-a may be configured such that the feedback may be transmitted after a number (X) of NACKs within M transmissions or within X PDSCH transmissions. In some cases, X may be configured via control signaling (e.g., an RRC or MAC-CE) transmitted by the device 405-a.

For example, in the case of semi-persistent signaling (SPS), the device 405-a may transmit a DCI that may trigger a set of PDSCH transmissions. The transmitted DCI may also include a configuration for reporting feedback (e.g., indicating a suitable configuration for transmitting reference signals). For example, a DCI transmitted during activation of a cell may trigger a set of PDSCH transmissions. The DCI may also indicate a timing between the DCI and the first PDSCH transmission (e.g., of the triggered set of PDSCH transmissions) as well as a timing between the first PDSCH transmission and an interval in which the feedback may be transmitted. In some cases, the timing indication (e.g., indicating an interval in which feedback may be transmitted) may be included in the RRC message, for example as part of an SPS configuration. Stated alternatively, when a periodicity between transmissions is configured in an RRC message, the RRC message may also indicate resources for HARQ transmissions. As such, the configuration may include a timing between the DCI transmission and the first PDSCH transmission (e.g., of the triggered set of PDSCH transmission) and timing between the first PDSCH transmission and the transmission of HARQ feedback.

In some examples, the device 405-b may multiplex feedback indicating a suitable reference signal configuration (e.g., a PTRS, a TRS, or a DMRS configuration) with HARQ feedback. For example, in separate PUCCH transmissions or a PUSCH resource. In some cases, the device 405-b may report feedback in a PUSCH. In such cases, the device 405-b may transmit a request for the device 405-a to transmit a reference signal configuration in a PUCCH. In response, the device 405-a may transmit resources for such reporting. For example, the device 405-a may transmit a signal to the device 405-b (e.g., via an RRC or MAC-CE). In some cases, the signaling may be transmitted dynamically in a DCI to indicate whether additional feedback of DMRS information reporting is enabled or disabled. In some cases, the DCI may indicate whether additional feedback of downlink reference signal reporting may be transmitted for a negative acknowledgment (NACK), a positive acknowledgement (ACK), or both (e.g., may not depend on the decoding status). In some cases, for example if three states are available, the additional feedback may be 2 bits. In some other cases, for example if two states are available (e.g., NACK or ACK and NACK), the additional feedback may be a single bit. In some cases, the device 405-a may indicate the number of bits, K, to report the additional feedback of DL-RS reporting. In some cases, the RRC may indicate the SPS periodicity and HARQ-ACK feedback resources.

As illustrated in the example of FIG. 4, the device 405-b may transmit feedback indicating a suitable configuration for transmitting reference signals after receiving a PDSCH. For example, the device 405-b may receive one or more PDSCH transmissions 420 from the device 405-a. The device 405-b may then determine HARQ-ACK and channel state information (CSI), such as HARQ-ACK and CSI 425, based on the decoding status of the received PDSCH transmissions 420. For example, the device 405-b may not successfully decode the PDSCH transmission 420-a. As such, the feedback (e.g., the HARQ-ACK and CSI 425-a) may include a NACK (e.g., a NACK 430-a). The device 405-b may transmit an indication of the NACK 430-a in a first transmission 440 (e.g., a first PUCCH) and an indication of a suitable configuration for transmitting reference signals (e.g., a pattern 435-a) in a second transmission 445 (e.g., a PUCCH or a PUSCH transmission). In some cases, the device 405-b may transmit both indications in a single transmission (e.g., may multiplex the indication of the pattern 435-a with the NACK 430-a).

In some other examples, the device 405-b may successfully decode the PDSCH transmission 420-b. As such, the feedback (e.g., the HARQ-ACK and CSI 425-b) may include an ACK (e.g., an ACK 430-b). In such an example, the device 405-b may transmit an indication of the ACK 430-b in a first transmission 440 and an indication of a suitable configuration for transmitting reference signals (e.g., a pattern 435-b) in a second transmission 445. In some cases, the device 405-b may refrain from transmitting an indication of a suitable configuration for transmitting reference signals (e.g., because the decoding was successful) and, in some other cases, the device 405-b may transmit both indications in a single transmission (e.g., may multiplex the indication of the pattern 435-b with the ACK 430-b).

The device 405-a may indicate a mode of operation to the device 405-b. In such cases, the mode of operation may indicate one or more enabled reference signals. For example, the mode of operation may indicate that DMRSs are enabled, TRS are enabled, PTRS are enabled, or combination thereof. In some cases, the configuration for the enabled reference signals may be configured by control signaling (e.g., a RRC, MAC-CE, or DCI). In such cases, the configuration may be indicated by a bitmap (e.g., a 3-bit bitmap) indicating which reference signal config may be sent in the report. In some cases, one or more reference signals may not be enabled (e.g., may be disabled). In such cases, the device 405-b may transmit an indication to enable disabled reference signals (e.g., enable transmission of the disabled reference signals). Stated alternatively, the device 405-b may transmit a request to enable or disable reference signals.

For example, PTRS (or another type of reference signal) may not be enabled. In such an example, the device 405-a may enable PTRSs based on a request from the device 405-b. In some examples, the indication (e.g., request) may be reported in the feedback indicating a suitable configuration for transmitting reference signals. For example, the device 405-b may indicate the request to enable the reference signals by adding one or more bits into the report (e.g., the feedback report). Stated alternatively, the feedback report may include an indication of suitable DMRS configuration, a suitable TRS configuration and a bit to enable PTRS reference signals. In another example, PTRS (or another reference signal) may be enabled. In such an example, the feedback report may include an indication of a suitable DMRS configuration, a suitable TRS configuration, and a suitable PTRS configuration.

In some cases, the device 405-b may also indicate a request to increase the time-density or frequency-density of one or more types of reference signals (e.g., DMRS, PTRS, or TRS). In some cases, the device 405-b may report a suitable configuration (e.g., pattern) based on doppler and delay spreads, or the like. For PTRS, the device 405-b may report the time-density or frequency-densities. For example, the frequency-density may be reported as 0, 2, or 4 and the time-density may be reported as 0, 1, 2, or 4.

A DMRS configuration, a PTRS configuration, and a TRS configuration may be reported from the device 405-b, to the device 405-a, to be used as additional information for future transmissions or retransmission of the current data transport block. For example, after receiving the signal, the device 405-b may estimate the channel parameters, and may determine the suitable DMRS configuration. In some cases, the configuration may include a pattern, a number of ports, a DMRS type, among other examples. Additionally or alternatively, the device 405-b may indicate a type of refence signal, from the enabled reference signals, that may provide the highest quality of channel.

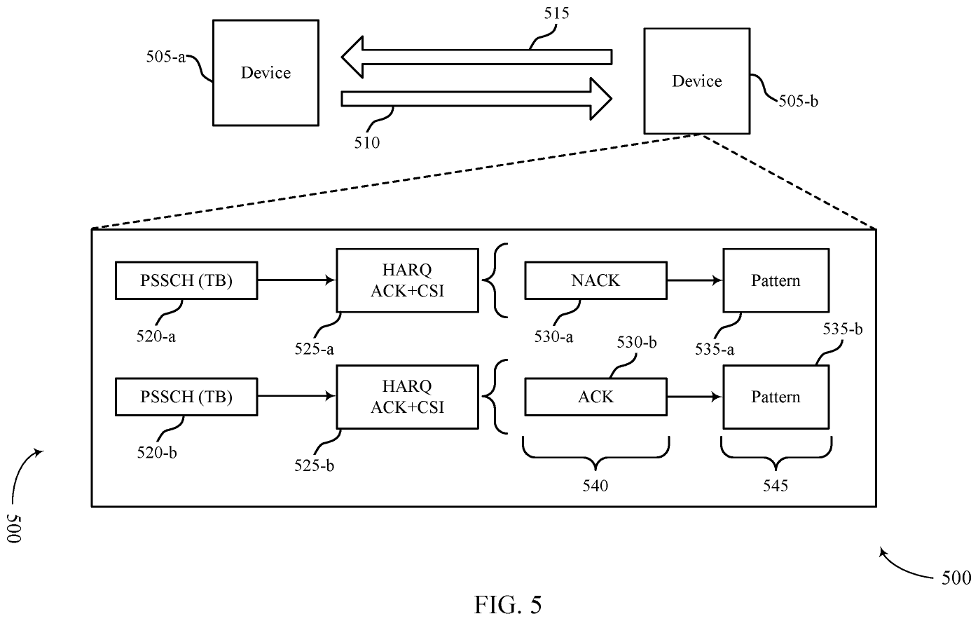

FIG. 5 illustrates an example of a process flow 500 that supports that supports sidelink reference signal and downlink reference signal configuration reporting in accordance with aspects of the present disclosure. The process flow 500 may implement or be implemented by one or more aspects of the wireless communications system 100 and the wireless communications system 200. For example, the process flow 500 may include a device 505-a and a device 505-b, which may be examples of devices as discussed with reference to FIG. 1. In the example of FIG. 5, the device 505-a may be a transmitting device (e.g., a UE 115), while the device 505-b may be a receiving device (e.g., a UE 115). The process flow 500 illustrates communications between the device 505-a and the device 505-b. For example, the device 505-a and the device 505-b may communicate over the communication link 510 (e.g., a sidelink) and the communication link 515 (e.g., a sidelink).

In some cases, the device 505-b may determine, based on multiple receptions of PSSCH transmissions (e.g., 1, 2, or 4 transmissions), a suitable configuration (e.g., pattern) for transmitting sidelink reference signals. In some cases, the device 505-b may determine a pattern from a set of patterns (e.g., Nₚₐₜₜₑᵣₙ). In some examples, a set of Nₚₐₜₜₑᵣₙ may be associated with a resource pool. In some cases, the device 505-b may transmit feedback indicating the determined configuration. For example, in response to receiving a PSSCH transmission (e.g., or a set of PSSCH transmissions) from the device 505-a, the device 505-b may indicate a pattern index (e.g., associated with a pattern from the set of Nₚₐₜₜₑᵣₙ). In some cases, if Nₚₐₜₜₑᵣₙ is equal to 3, the device 505-b may use 2 bits to transmit the feedback. In some cases, the device 505-b may report a time-density configuration (e.g., from one or more time-density configurations) or a frequency-density configuration (e.g., from one or more time-density configurations) for sidelink PTRSs. In some cases, the device 505-b may indicate the time-density configuration via an IE, such as the timeDensity IE and the frequency-density configuration via and IE, such as the frequency Desnity IE.

In some other cases, the device 505-b may indicate, to the device 505-a, an index that may correspond to the index of a suitable configuration to use for communications (e.g., transmitting reference signals). In some examples, the configuration may indicate a suitable pattern for transmitting DMRS signals (e.g., a DMRS pattern), a configuration for PSSCH allocations, or a configuration for sidelink PTRS. For example, the device 505-b may indicate, to the device 505-a, an index of a resource pool (e.g., or set of resource pools). The one or more of the resource pools (e.g., of the set of resource pools) may be resource pools that the device 505-b and the device 505-a use for the communications (e.g., transmission and receptions).

The device 505-a may be configured to transmit on the resource pools RP1, RP2, and RP4, and the device 505-b may be configured to receive on the resource pools RP1, RP2, RP4, and RP6. Therefore, the set of resource pools may include RP1, RP2, and RP4. In some cases, each resource pool may be configured with set of PTRSs and a set of DMRSs. In such cases, the device 505-b may determine a resource pool based on the configured set of PTRS and DMRSs. In some other cases, the device 505-b may determine a resource pool based on measurements performed at the device 505-b. In some cases, time-domain PSSCH allocations (e.g., resources for data transmissions) may be configured per resource pool. In some examples, the feedback may be transmitted in a PSFCH transmission, a MAC-CE, or in a transmission over a PSSCH dedicated to the device 505-b.

As illustrated in the example of FIG. 5, the device 505-b may transmit feedback indicating a suitable configuration for transmitting reference signals after receiving a PSSCH. For example, the device 505-b may receive one or more PSSCH transmissions 520 from the device 505-a. The device 505-b may determine HARQ-ACK and CSI (e.g., HARQ-ACK and CSI 525) based on the decoding status of the received PSSCH transmissions 520. For example, the device 505-b may not successfully decode the PSSCH transmission 520-a. As such, the feedback (e.g., the HARQ-ACK and CSI 525-a) may include a NACK (e.g., a NACK 530-a). In such an example, the device 505-b may transmit an indication of the NACK 530-a in a first transmission 540 (e.g., a first stage PSFCH transmission) and an indication of a suitable configuration for transmitting reference signals (e.g., a pattern 535-a) in a second transmission 545 (e.g., a second stage PSFCH transmission). In some other examples, the device 505-b may successfully decode the PSSCH transmission 520-b. As such, the feedback (e.g., the HARQ-ACK and CSI feedback 525-b) may include an ACK (e.g., an ACK 530-b). In such an example, the device 505-b may transmit an indication of the ACK 530-b in a first transmission 540 and an indication of a suitable configuration for transmitting reference signals (e.g., a pattern 535-b) in a second transmission 545. In some cases, transmitting an indication of suitable configuration for transmitting reference signals may not depend on the decoding status, in such cases, the device 505-b may transmit the indication and the HARQ feedback in a single transmission.

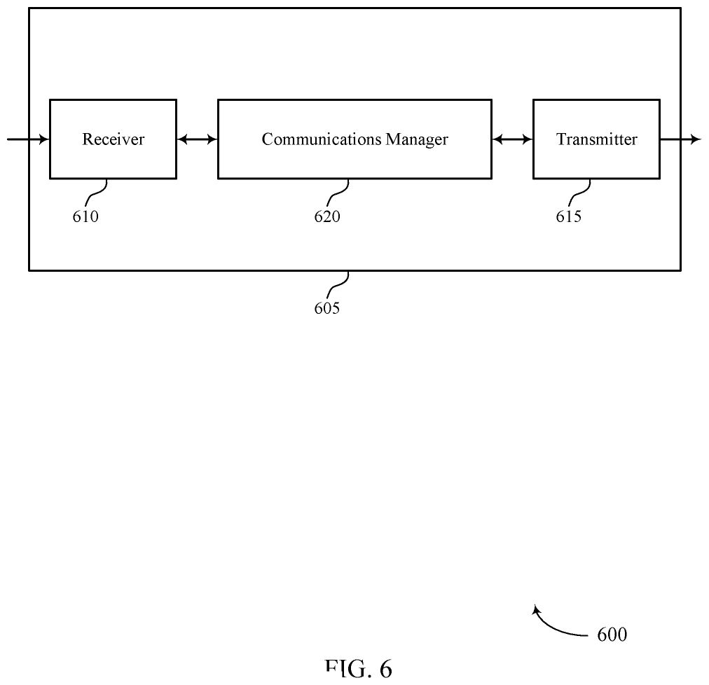

FIG. 6 shows a block diagram 600 of a device 605 that supports sidelink reference signal and downlink reference signal configuration reporting in accordance with aspects of the present disclosure. The device 605 may be an example of aspects of a UE 115 or a communication device as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink reference signal and downlink reference signal configuration reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink reference signal and downlink reference signal configuration reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of sidelink reference signal and downlink reference signal configuration reporting as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first device (e.g., the device 605) in accordance with examples as disclosed herein. For example, the communications manager 620 may be configured as or otherwise support a means for receiving, from a second device (e.g., a base station 105 or a relay UE 115), a set of transmissions over a shared channel. The communications manager 620 may be configured as or otherwise support a means for determining at least one of a Doppler spread or a delay spread based on the received set of transmissions over the shared channel. The communications manager 620 may be configured as or otherwise support a means for selecting a reference signal configuration from a set of multiple reference signal configurations. The communications manager 620 may select the reference signal configuration based on determining at least one of the Doppler spread or the delay spread. The communications manager 620 may be configured as or otherwise support a means for transmitting, to the second device (e.g., the base station 105 or the relay UE 115), feedback indicating the selected reference signal configuration for a subsequent set of transmissions over the shared channel.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing and more efficient utilization of communication resources.

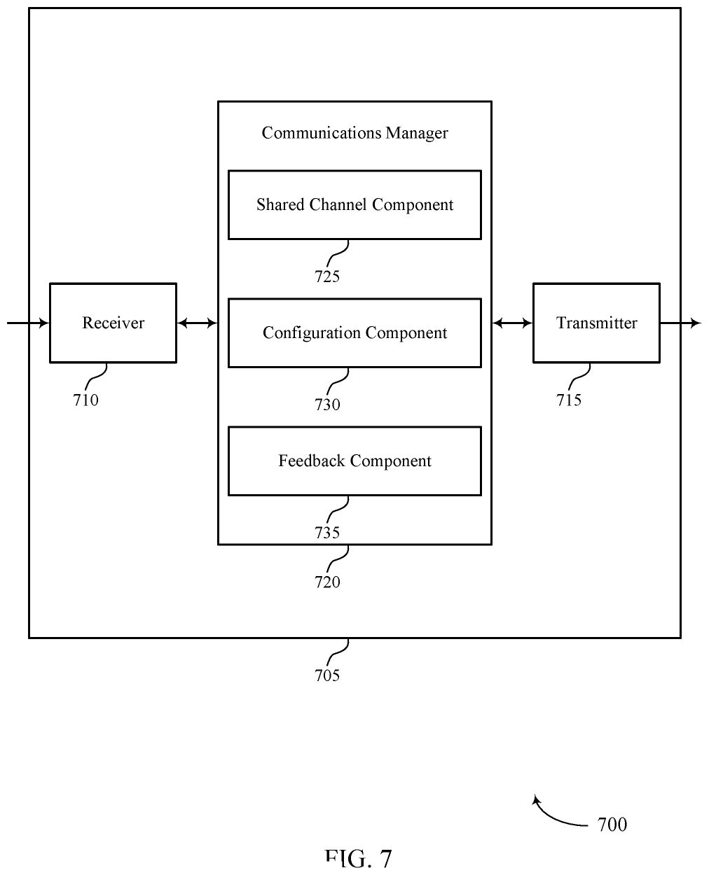

FIG. 7 shows a block diagram 700 of a device 705 that supports sidelink reference signal and downlink reference signal configuration reporting in accordance with aspects of the present disclosure. The device 705 may be an example of aspects of a device 605, a UE 115, or a communication device as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to sidelink reference signal and downlink reference signal configuration reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to sidelink reference signal and downlink reference signal configuration reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of sidelink reference signal and downlink reference signal configuration reporting as described herein. For example, the communications manager 720 may include a shared channel component 725, a configuration component 730, a feedback component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first device (e.g., the device 705) in accordance with examples as disclosed herein. The shared channel component 725 may be configured as or otherwise support a means for receiving, from a second device (e.g., a base station 105 or a relay UE 115), a set of transmissions over a shared channel. The shared channel component 725 may be configured as or otherwise support a means for determining at least one of a Doppler spread or a delay spread based on the received set of transmissions over the shared channel. The configuration component 730 may be configured as or otherwise support a means for selecting a reference signal configuration from a set of multiple reference signal configurations. The configuration component 730 may select a reference signal configuration based on determining at least one of the Doppler spread or the delay spread. The feedback component 735 may be configured as or otherwise support a means for transmitting, to the second device (e.g., the base station 105 or the relay UE 115), feedback indicating the selected reference signal configuration for a subsequent set of transmissions over the shared channel.

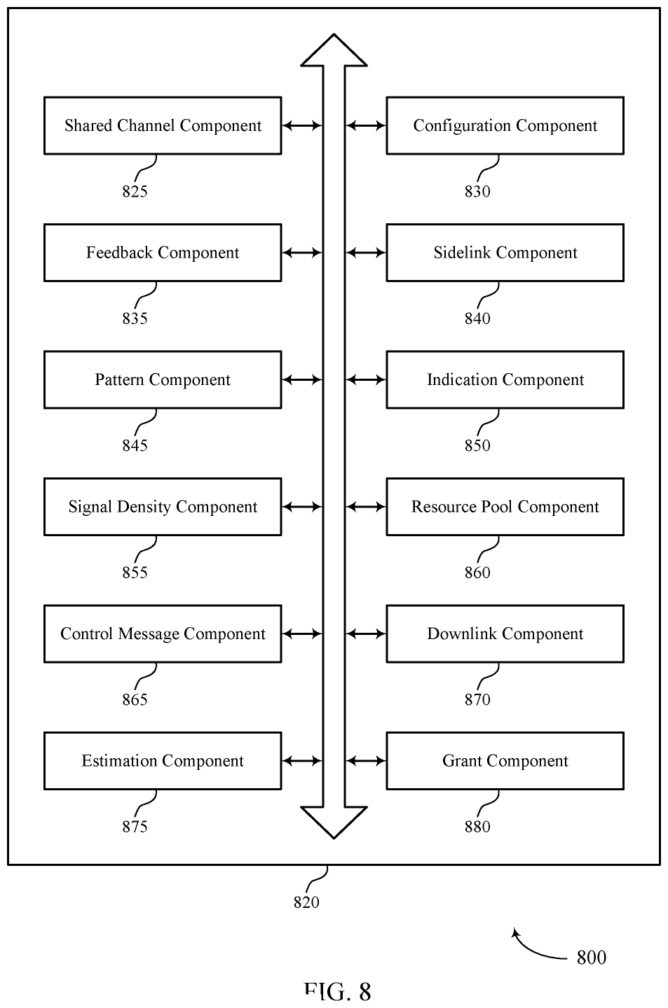

FIG. 8 shows a block diagram 800 of a communications manager 820 that supports sidelink reference signal and downlink reference signal configuration reporting in accordance with aspects of the present disclosure. The communications manager 820 may be an example of aspects of a communications manager 620, a communications manager 720, or both, as described herein. The communications manager 820, or various components thereof, may be an example of means for performing various aspects of sidelink reference signal and downlink reference signal configuration reporting as described herein. For example, the communications manager 820 may include a shared channel component 825, a configuration component 830, a feedback component 835, a sidelink component 840, a pattern component 845, an indication component 850, a signal density component 855, a resource pool component 860, a control message component 865, a downlink component 870, an estimation component 875, a grant component 880, or any combination thereof. Each of these components may communicate, directly or indirectly, with one another (e.g., via one or more buses).

The communications manager 820 may support wireless communication at a first device (e.g., a UE) in accordance with examples as disclosed herein. The shared channel component 825 may be configured as or otherwise support a means for receiving, from a second device (e.g., a base station or a relay UE), a set of transmissions over a shared channel. In some examples, the shared channel component 825 may be configured as or otherwise support a means for determining at least one of a Doppler spread or a delay spread based on the received set of transmissions over the shared channel. The configuration component 830 may be configured as or otherwise support a means for selecting a reference signal configuration from a set of multiple reference signal configurations based on determining at least one of the Doppler spread or the delay spread. The feedback component 835 may be configured as or otherwise support a means for transmitting, to the base station or relay UE, feedback indicating the selected reference signal configuration for a subsequent set of transmissions over the shared channel.

In some examples, to support receiving the set of transmissions, the sidelink component 840 may be configured as or otherwise support a means for receiving, from the base station or relay UE, one or more sidelink transmissions over a sidelink shared channel. In some examples, to support receiving the set of transmissions, the configuration component 830 may be configured as or otherwise support a means for selecting the reference signal configuration from the set of multiple reference signal configurations based on the received one or more sidelink transmissions over the sidelink shared channel.

In some examples, to support selecting the reference signal configuration from the set of multiple reference signal configurations, the pattern component 845 may be configured as or otherwise support a means for selecting a DMRS pattern from a set of DMRS patterns based on determining at least one of the Doppler spread or the delay spread. In some examples, to support selecting the reference signal configuration from the set of multiple reference signal configurations, the indication component 850 may be configured as or otherwise support a means for transmitting, to a second device (e.g., a base station 105 or UE 115), an indication of the selected DMRS pattern. In some examples, the indication includes a bitmap.

In some examples, the signal density component 855 may be configured as or otherwise support a means for determining a reference signal density associated with the received set of transmissions over the shared channel, the reference signal density including a sidelink PTRS density in at least one of a time domain or a frequency domain. In some examples, the indication component 850 may be configured as or otherwise support a means for transmitting, to the base station or relay UE, an indication of the sidelink PTRS density in at least one of the time domain or the frequency domain.

In some examples, the resource pool component 860 may be configured as or otherwise support a means for determining at least one of a resource pool or a set of resource pools for the wireless communication based on the selected reference signal configuration, at least one of the resource pool or the set of resource pools corresponding to one or more of a DMRS pattern or a set of DMRS patterns, a sidelink shared channel allocation, a set of sidelink shared channel allocations, a sidelink PTRS configuration, or a set of sidelink PTRS configurations. In some examples, the indication component 850 may be configured as or otherwise support a means for transmitting, to the base station or relay UE, an indication of at least one of the resource pool or the set of resource pools for the wireless communication.

In some examples, to support transmitting the feedback, the feedback component 835 may be configured as or otherwise support a means for transmitting, to the base station or relay UE, the feedback indicating the selected reference signal configuration in a medium access control-control element. Additionally or alternatively, to support transmitting the feedback, the feedback component 835 may be configured as or otherwise support a means for transmitting, to the base station or relay UE, the feedback indicating the selected reference signal configuration over a sidelink feedback channel or a sidelink shared channel.

In some examples, the control message component 865 may be configured as or otherwise support a means for receiving, from the base station or relay UE, a control message including an indication to transmit the feedback indicating the selected reference signal configuration, the control message including a sidelink control information message. In some examples, the feedback component 835 may be configured as or otherwise support a means for transmitting the feedback indicating the selected reference signal configuration is based on the received control message.

In some examples, to support receiving the set of transmissions, the downlink component 870 may be configured as or otherwise support a means for receiving, from the second device, one or more downlink transmissions over a downlink shared channel. In some examples, to support receiving the set of transmissions, the estimation component 875 may be configured as or otherwise support a means for estimating at least one of the Doppler spread or the delay spread based on the received one or more downlink transmissions over the downlink shared channel. In some examples, to support receiving the set of transmissions, the configuration component 830 may be configured as or otherwise support a means for selecting the reference signal configuration from the set of multiple reference signal configurations is based on estimating at least one of the Doppler spread or the delay spread, the selected reference signal configuration indicating one or more of a reference signal type, a reference signal pattern, a set of antenna ports, or a reference signal satisfying a criterion.

In some examples, the grant component 880 may be configured as or otherwise support a means for receiving, from the base station or relay UE, a grant including a resource allocation based on transmitting a scheduling request for the resource allocation to transmit the feedback indicating the selected reference signal configuration. In some examples, the feedback component 835 may be configured as or otherwise support a means for determining one or more resources to transmit the feedback indicating the selected reference signal configuration based on the resource allocation. In some examples, the feedback component 835 may be configured as or otherwise support a means for transmitting, to the base station or relay UE, feedback indicating the selected reference signal configuration using the one or more resources.

In some examples, the feedback component 835 may be configured as or otherwise support a means for multiplexing a first uplink channel associated with the feedback indicating the selected reference signal configuration and a second uplink channel associated with a HARQ feedback, at least one of the first uplink channel or the second uplink channel including an uplink control channel or an uplink shared channel. In some examples, transmitting the feedback indicating the selected reference signal configuration is based on the multiplexing.

In some examples, the control message component 865 may be configured as or otherwise support a means for receiving control signaling including an indication of a criterion for transmitting the feedback indicating the selected reference signal configuration, the criterion indicating to transmit the feedback after receiving a number of transmissions of the set of transmissions, the control signaling including one or more of an RRC message, a MAC-CE, or a DCI. In some examples, the feedback component 835 may be configured as or otherwise support a means for transmitting the feedback indicating the selected reference signal configuration is based on the received control signaling.

In some examples, the RRC message includes an SPS configuration including the indication of the criterion for transmitting the feedback indicating the selected reference signal configuration. In some examples, the control message component 865 may be configured as or otherwise support a means for receiving, from the base station or relay UE, control signaling indicating a mode of operation for transmitting reference signals, the mode of operation corresponding to one or more types of reference signals enabled, the one or more types of reference signals including one or more of DMRSs, TRSs, or PTRSs. In some examples, transmitting the feedback indicating the selected reference signal configuration is based on the mode of operation. In some examples, the feedback includes at least one of an indication to enable a reference signal or adjust a reference signal density in at least one of a time domain associated with the reference signal or a frequency domain associated with the reference signal.

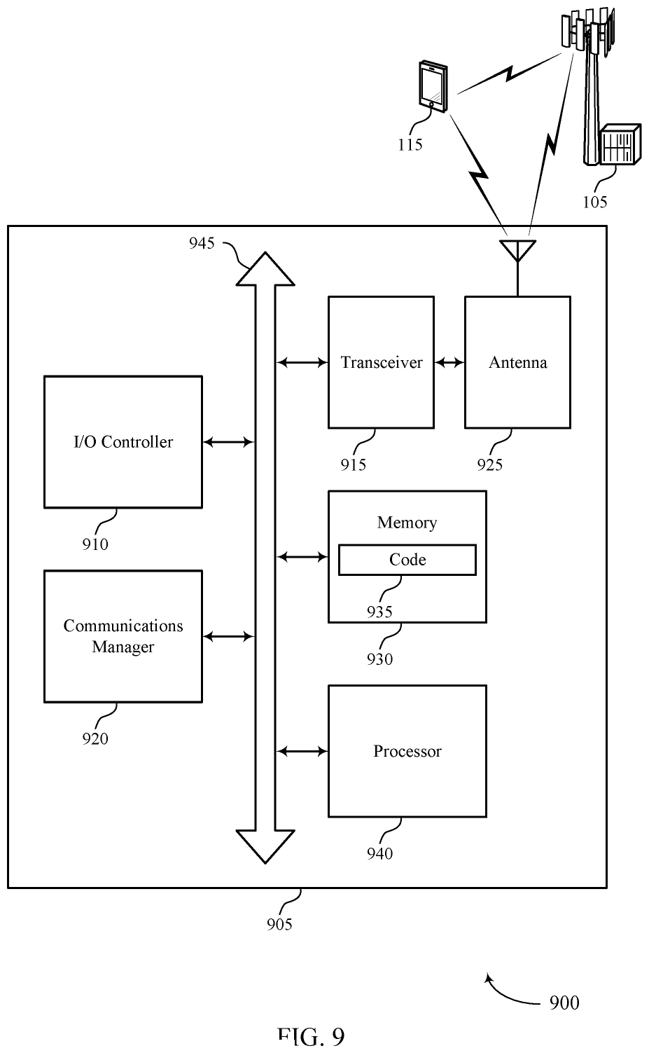

FIG. 9 shows a diagram of a system 900 including a device 905 that supports sidelink reference signal and downlink reference signal configuration reporting in accordance with aspects of the present disclosure. The device 905 may be an example of or include the components of a device 605, a device 705, a UE 115, or a communication device as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting sidelink reference signal and downlink reference signal configuration reporting). For example, the device 905 or a component of the device 905 may include a processor 940 and memory 930 coupled to the processor 940, the processor 940 and memory 930 configured to perform various functions described herein.

The communications manager 920 may support wireless communication at a first device (e.g., the device 905) in accordance with examples as disclosed herein. For example, the communications manager 920 may be configured as or otherwise support a means for receiving, from a second device (e.g., a base station or a relay UE), a set of transmissions over a shared channel. The communications manager 920 may be configured as or otherwise support a means for determining at least one of a Doppler spread or a delay spread based on the received set of transmissions over the shared channel. The communications manager 920 may be configured as or otherwise support a means for selecting a reference signal configuration from a set of multiple reference signal configurations based on determining at least one of the Doppler spread or the delay spread. The communications manager 920 may be configured as or otherwise support a means for transmitting, to the base station or relay UE, feedback indicating the selected reference signal configuration for a subsequent set of transmissions over the shared channel. By including or configuring the communications manager 920 in accordance with examples as described herein, the device 905 may support techniques for improved communication reliability, reduced latency, improved user experience related to reduced processing, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of sidelink reference signal and downlink reference signal configuration reporting as described herein, or the processor 940 and the memory 930 may be otherwise configured to perform or support such operations.

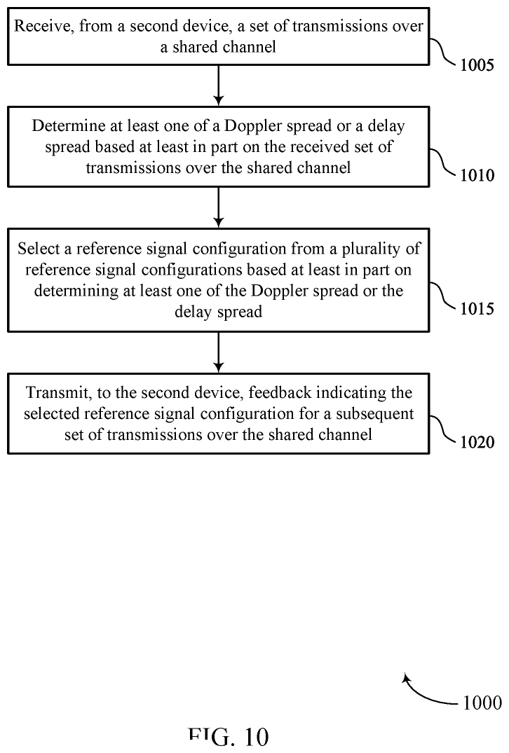

FIG. 10 shows a flowchart illustrating a method 1000 that supports sidelink reference signal and downlink reference signal configuration reporting in accordance with aspects of the present disclosure. The operations of the method 1000 may be implemented by a device or its components as described herein. For example, the operations of the method 1000 may be performed by a UE as described with reference to FIGS. 1 through 9. In some examples, a device may execute a set of instructions to control the functional elements of the device to perform the described functions. Additionally or alternatively, the device may perform aspects of the described functions using special-purpose hardware.

At 1005, the method may include receiving, from a second device, a set of transmissions over a shared channel. The operations of 1005 may be performed in accordance with examples as disclosed herein. In some examples, aspects of the operations of 1005 may be performed by a shared channel component 825 as described with reference to FIG. 8.

At 1010, the method may include determining at least one of a Doppler spread or a delay spread based on the received set of transmissions over the shared channel. The operations of 1010 may be performed in accordance with examples as disclosed herein. In some examples, aspects of the operations of 1010 may be performed by a shared channel component 825 as described with reference to FIG. 8.

At 1015, the method may include selecting a reference signal configuration from a set of multiple reference signal configurations based on determining at least one of the Doppler spread or the delay spread. The operations of 1015 may be performed in accordance with examples as disclosed herein. In some examples, aspects of the operations of 1015 may be performed by a configuration component 830 as described with reference to FIG. 8.

At 1020, the method may include transmitting, to the second device, feedback indicating the selected reference signal configuration for a subsequent set of transmissions over the shared channel. The operations of 1020 may be performed in accordance with examples as disclosed herein. In some examples, aspects of the operations of 1020 may be performed by a feedback component 835 as described with reference to FIG. 8.

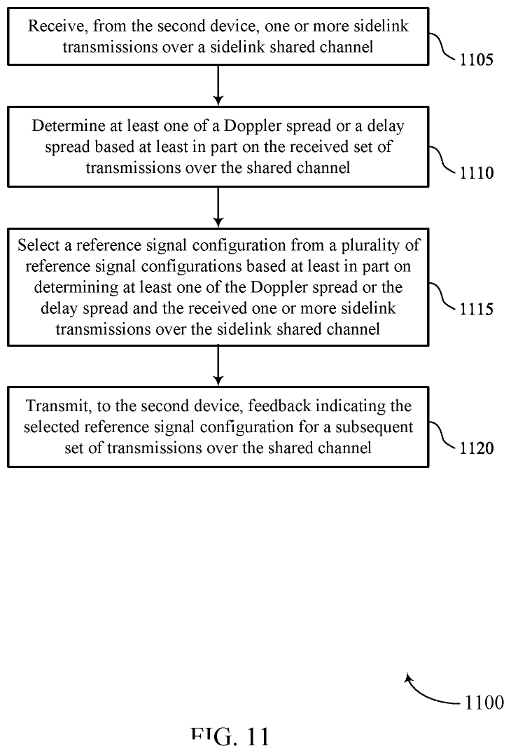

FIG. 11 shows a flowchart illustrating a method 1100 that supports sidelink reference signal and downlink reference signal configuration reporting in accordance with aspects of the present disclosure. The operations of the method 1100 may be implemented by a device or its components as described herein. For example, the operations of the method 1100 may be performed by a UE as described with reference to FIGS. 1 through 9. In some examples, a device may execute a set of instructions to control the functional elements of the device to perform the described functions. Additionally or alternatively, the device may perform aspects of the described functions using special-purpose hardware.

At 1105, the method may include receiving, from a second device, one or more sidelink transmissions over a sidelink shared channel. In some examples, the second device may be a base station or a UE (such as, a relay UE). The operations of 1105 may be performed in accordance with examples as disclosed herein. In some examples, aspects of the operations of 1105 may be performed by a sidelink component 840 as described with reference to FIG. 8.

At 1110, the method may include determining at least one of a Doppler spread or a delay spread based on the received set of transmissions over the shared channel. The operations of 1110 may be performed in accordance with examples as disclosed herein. In some examples, aspects of the operations of 1110 may be performed by a shared channel component 825 as described with reference to FIG. 8.

At 1115, the method may include selecting a reference signal configuration from a set of multiple reference signal configurations based on determining at least one of the Doppler spread or the delay spread and the received one or more sidelink transmissions over the sidelink shared channel. The operations of 1115 may be performed in accordance with examples as disclosed herein. In some examples, aspects of the operations of 1115 may be performed by a configuration component 830 as described with reference to FIG. 8.

At 1120, the method may include transmitting, to the second device, feedback indicating the selected reference signal configuration for a subsequent set of transmissions over the shared channel. The operations of 1120 may be performed in accordance with examples as disclosed herein. In some examples, aspects of the operations of 1120 may be performed by a feedback component 835 as described with reference to FIG. 8.

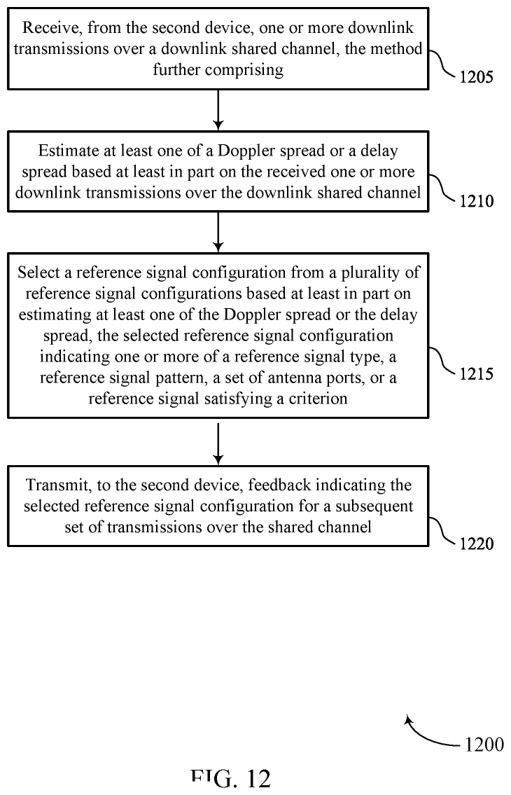

FIG. 12 shows a flowchart illustrating a method 1200 that supports sidelink reference signal and downlink reference signal configuration reporting in accordance with aspects of the present disclosure. The operations of the method 1200 may be implemented by a device or its components as described herein. For example, the operations of the method 1200 may be performed by a UE as described with reference to FIGS. 1 through 9. In some examples, a device may execute a set of instructions to control the functional elements of the device to perform the described functions. Additionally or alternatively, the device may perform aspects of the described functions using special-purpose hardware.

At 1205, the method may include receiving, from a second device, one or more downlink transmissions over a downlink shared channel. The operations of 1205 may be performed in accordance with examples as disclosed herein. In some examples, aspects of the operations of 1205 may be performed by a downlink component 870 as described with reference to FIG. 8.

At 1210, the method may include estimating at least one of a Doppler spread or a delay spread based on the received one or more downlink transmissions over the downlink shared channel. The operations of 1210 may be performed in accordance with examples as disclosed herein. In some examples, aspects of the operations of 1210 may be performed by an estimation component 875 as described with reference to FIG. 8.

At 1215, the method may include selecting the reference signal configuration from the set of multiple reference signal configurations is based on estimating at least one of the Doppler spread or the delay spread, the selected reference signal configuration indicating one or more of a reference signal type, a reference signal pattern, a set of antenna ports, or a reference signal satisfying a criterion. The operations of 1215 may be performed in accordance with examples as disclosed herein. In some examples, aspects of the operations of 1215 may be performed by a configuration component 830 as described with reference to FIG. 8.

At 1220, the method may include transmitting, to the second device, feedback indicating the selected reference signal configuration for a subsequent set of transmissions over the shared channel. The operations of 1220 may be performed in accordance with examples as disclosed herein. In some examples, aspects of the operations of 1220 may be performed by a feedback component 835 as described with reference to FIG. 8.

The following provides an overview of aspects of the present disclosure:

Aspect 1: A method for wireless communication at a first device, comprising: receiving, from a second device, a set of transmissions over a shared channel; determining at least one of a Doppler spread or a delay spread based at least in part on the received set of transmissions over the shared channel; selecting a reference signal configuration from a plurality of reference signal configurations based at least in part on determining at least one of the Doppler spread or the delay spread; and transmitting, to the second device, feedback indicating the selected reference signal configuration for a subsequent set of transmissions over the shared channel.

Aspect 2: The method of aspect 1, wherein receiving the set of transmissions comprises: receiving, from the second device, one or more sidelink transmissions over a sidelink shared channel, wherein selecting the reference signal configuration from the plurality of reference signal configurations is based at least in part on the received one or more sidelink transmissions over the sidelink shared channel.

Aspect 3: The method of any of aspects 1 through 2, wherein selecting the reference signal configuration from the plurality of reference signal configurations comprises: selecting a DMRS pattern from a set of DMRS patterns based at least in part on determining at least one of the Doppler spread or the delay spread, wherein transmitting the feedback comprises: transmitting, to the second device, an indication of the selected DMRS pattern.

Aspect 4: The method of aspect 3, wherein the indication comprises a bitmap.

Aspect 5: The method of any of aspects 1 through 4, further comprising: determining a reference signal density associated with the received set of transmissions over the shared channel, the reference signal density comprising a sidelink PTRS density in at least one of a time domain or a frequency domain, wherein transmitting the feedback comprises: transmitting, to the second device, an indication of the sidelink PTRS density in at least one of the time domain or the frequency domain.

Aspect 6: The method of any of aspects 1 through 5, further comprising: determining at least one of a resource pool or a set of resource pools for the wireless communication based at least in part on the selected reference signal configuration, at least one of the resource pool or the set of resource pools corresponding to one or more of a DMRS pattern or a set of DMRS patterns, a sidelink shared channel allocation, a set of sidelink shared channel allocations, a sidelink PTRS configuration, or a set of sidelink PTRS configurations, wherein transmitting the feedback comprises: transmitting, to the second device, an indication of at least one of the resource pool or the set of resource pools for the wireless communication.

Aspect 7: The method of any of aspects 1 through 6, wherein transmitting the feedback comprises: transmitting, to the second device, the feedback indicating the selected reference signal configuration in a MAC-CE.

Aspect 8: The method of any of aspects 1 through 7, wherein transmitting the feedback comprises: transmitting, to the second device, the feedback indicating the selected reference signal configuration over a sidelink feedback channel or a sidelink shared channel.

Aspect 9: The method of any of aspects 1 through 8, further comprising: receiving, from the second device, a control message comprising an indication to transmit the feedback indicating the selected reference signal configuration, the control message comprising a sidelink control information message, wherein transmitting the feedback indicating the selected reference signal configuration is based at least in part on the received control message.

Aspect 10: The method of any of aspects 1 through 9, wherein receiving the set of transmissions comprises: receiving, from the second device, one or more downlink transmissions over a downlink shared channel, the method further comprising: estimating at least one of the Doppler spread or the delay spread based at least in part on the received one or more downlink transmissions over the downlink shared channel, wherein selecting the reference signal configuration from the plurality of reference signal configurations is based at least in part on estimating at least one of the Doppler spread or the delay spread, the selected reference signal configuration indicating one or more of a reference signal type, a reference signal pattern, a set of antenna ports, or a reference signal satisfying a criterion.

Aspect 11: The method of any of aspects 1 through 10, further comprising: receiving, from the second device, a grant comprising a resource allocation based at least in part on transmitting a scheduling request for the resource allocation to transmit the feedback indicating the selected reference signal configuration; and determining one or more resources to transmit the feedback indicating the selected reference signal configuration based at least in part on the resource allocation, wherein transmitting the feedback comprises: transmitting, to the second device, the feedback indicating the selected reference signal configuration using the one or more resources.

Aspect 12: The method of aspect 11, further comprising: multiplexing a first uplink channel associated with the feedback indicating the selected reference signal configuration and a second uplink channel associated with a hybrid automatic repeat request feedback, at least one of the first uplink channel or the second uplink channel comprising an uplink control channel or an uplink shared channel, wherein transmitting the feedback indicating the selected reference signal configuration is based at least in part on the multiplexing.

Aspect 13: The method of any of aspects 1 through 12, further comprising: receiving control signaling comprising an indication of a criterion for transmitting the feedback indicating the selected reference signal configuration, the criterion indicating to transmit the feedback after receiving a number of transmissions of the set of transmissions, the control signaling comprising one or more of an RRC message, a MAC-CE, or a DCI, wherein transmitting the feedback indicating the selected reference signal configuration is based at least in part on the received control signaling.

Aspect 14: The method of aspect 13, wherein the radio resource control message comprises a semi-persistent scheduling configuration comprising the indication of the criterion for transmitting the feedback indicating the selected reference signal configuration.

Aspect 15: The method of any of aspects 1 through 14, further comprising: receiving, from the second device, control signaling indicating a mode of operation for transmitting reference signals, the mode of operation corresponding to one or more types of reference signals enabled, the one or more types of reference signals comprising one or more of DMRSs, tracking reference signals, or PTRSs.

Aspect 16: The method of aspect 15, wherein transmitting the feedback indicating the selected reference signal configuration is based at least in part on the mode of operation.

Aspect 17: The method of any of aspects 1 through 16, wherein the feedback comprises at least one of an indication to enable a reference signal or adjust a reference signal density in at least one of a time domain associated with the reference signal or a frequency domain associated with the reference signal.

Aspect 18: An apparatus for wireless communication at a first device, comprising a processor; memory coupled with the processor; and instructions stored in the memory and executable by the processor to cause the apparatus to perform a method of any of aspects 1 through 17.

Aspect 19: An apparatus for wireless communication at a first device, comprising at least one means for performing a method of any of aspects 1 through 17.

Aspect 20: A non-transitory computer-readable medium storing code for wireless communication at a first device, the code comprising instructions executable by a processor to perform a method of any of aspects 1 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first device, comprising:
receiving, from a second device, a set of transmissions over a shared channel;
determining at least one of a Doppler spread or a delay spread based at least in part on the received set of transmissions over the shared channel;
selecting a reference signal configuration from a plurality of reference signal configurations based at least in part on determining at least one of the Doppler spread or the delay spread; and
transmitting, to the second device, feedback indicating the selected reference signal configuration for a subsequent set of transmissions over the shared channel.

2. The method of claim 1, wherein receiving the set of transmissions comprises:
receiving, from the second device, one or more sidelink transmissions over a sidelink shared channel,
wherein selecting the reference signal configuration from the plurality of reference signal configurations is based at least in part on the received one or more sidelink transmissions over the sidelink shared channel.

3. The method of claim 1, wherein selecting the reference signal configuration from the plurality of reference signal configurations comprises:
selecting a demodulation reference signal pattern from a set of demodulation reference signal patterns based at least in part on determining at least one of the Doppler spread or the delay spread,
wherein transmitting the feedback comprises:
transmitting, to the second device, an indication of the selected demodulation reference signal pattern.

4. (canceled)

5. The method of claim 1, further comprising:
determining a reference signal density associated with the received set of transmissions over the shared channel, the reference signal density comprising a sidelink phase tracking reference signal density in at least one of a time domain or a frequency domain,
wherein transmitting the feedback comprises:
transmitting, to the second device, an indication of the sidelink phase tracking reference signal density in at least one of the time domain or the frequency domain.

6. The method of claim 1, further comprising:
determining at least one of a resource pool or a set of resource pools for the wireless communication based at least in part on the selected reference signal configuration, at least one of the resource pool or the set of resource pools corresponding to one or more of a demodulation reference signal pattern or a set of demodulation reference signal patterns, a sidelink shared channel allocation, a set of sidelink shared channel allocations, a sidelink phase tracking reference signal configuration, or a set of sidelink phase tracking reference signal configurations,
wherein transmitting the feedback comprises:
transmitting, to the second device, an indication of at least one of the resource pool or the set of resource pools for the wireless communication.

7. (canceled)

8. (canceled)

9. The method of claim 1, further comprising:
receiving, from the second device, a control message comprising an indication to transmit the feedback indicating the selected reference signal configuration, the control message comprising a sidelink control information message,
wherein transmitting the feedback indicating the selected reference signal configuration is based at least in part on the received control message.

10. The method of claim 1, wherein receiving the set of transmissions comprises:
receiving, from the second device, one or more downlink transmissions over a downlink shared channel, the method further comprising:
estimating at least one of the Doppler spread or the delay spread based at least in part on the received one or more downlink transmissions over the downlink shared channel,
wherein selecting the reference signal configuration from the plurality of reference signal configurations is based at least in part on estimating at least one of the Doppler spread or the delay spread, the selected reference signal configuration indicating one or more of a reference signal type, a reference signal pattern, a set of antenna ports, or a reference signal satisfying a criterion.

11. The method of claim 1, further comprising:
receiving, from the second device, a grant comprising a resource allocation based at least in part on transmitting a scheduling request for the resource allocation to transmit the feedback indicating the selected reference signal configuration; and
determining one or more resources to transmit the feedback indicating the selected reference signal configuration based at least in part on the resource allocation,
wherein transmitting the feedback comprises:
transmitting, to the second device, the feedback indicating the selected reference signal configuration using the one or more resources.

12. (canceled)

13. The method of claim 1, further comprising:
receiving control signaling comprising an indication of a criterion for transmitting the feedback indicating the selected reference signal configuration, the criterion indicating to transmit the feedback after receiving a number of transmissions of the set of transmissions, the control signaling comprising one or more of a radio resource control message, a medium access control-control element, or a downlink control information,
wherein transmitting the feedback indicating the selected reference signal configuration is based at least in part on the received control signaling.

14. (canceled)

15. The method of claim 1, further comprising:
receiving, from the second device, control signaling indicating a mode of operation for transmitting reference signals, the mode of operation corresponding to one or more types of reference signals enabled, the one or more types of reference signals comprising one or more of demodulation reference signals, tracking reference signals, or phase tracking reference signals.

16. (canceled)

17. The method of claim 1, wherein the feedback comprises at least one of an indication to enable a reference signal or adjust a reference signal density in at least one of a time domain associated with the reference signal or a frequency domain associated with the reference signal.

18. A first apparatus for wireless communication, comprising:
one or more memories storing processor-executable code; and
one or more processors coupled with the one or more memories and individually or collectively operable to execute the code to cause the first apparatus to:
receive, from a second apparatus, a set of transmissions over a shared channel;
determine at least one of a Doppler spread or a delay spread based at least in part on the received set of transmissions over the shared channel;
select a reference signal configuration from a plurality of reference signal configurations based at least in part on the determination of at least one of the Doppler spread or the delay spread; and
transmit, to the second apparatus, feedback indicating the selected reference signal configuration for a subsequent set of transmissions over the shared channel.

19. The first apparatus of claim 18, wherein, to receive the set of transmissions, the one or more processors are individually or collectively operable to execute the code to cause the first apparatus to:
receive, from the second apparatus, one or more sidelink transmissions over a sidelink shared channel,
wherein, to select the reference signal configuration from the plurality of reference signal configurations, the one or more processors are individually or collectively further operable to execute the code based at least in part on the received one or more sidelink transmissions over the sidelink shared channel.

20. The first apparatus of claim 18, wherein, to select the reference signal configuration from the plurality of reference signal configurations, the one or more processors are individually or collectively operable to execute the code to cause the first apparatus to:
select a demodulation reference signal pattern from a set of demodulation reference signal patterns based at least in part on the determination of at least one of the Doppler spread or the delay spread,
wherein, to transmit the feedback, the one or more processors are individually or collectively operable to execute the code to cause the first apparatus to:
transmit, to the second apparatus, an indication of the selected demodulation reference signal pattern.

21. (canceled)

22. The first apparatus of claim 18, wherein the one or more processors are individually or collectively further operable to execute the code to cause the first apparatus to:
determine a reference signal density associated with the received set of transmissions over the shared channel, the reference signal density comprising a sidelink phase tracking reference signal density in at least one of a time domain or a frequency domain,
wherein, to transmit the feedback, the one or more processors are individually or collectively operable to execute the code to cause the first apparatus to:
transmit, to the second apparatus, an indication of the sidelink phase tracking reference signal density in at least one of the time domain or the frequency domain.

23. The first apparatus of claim 18, wherein the one or more processors are individually or collectively further operable to execute the code to cause the first apparatus to:
determine at least one of a resource pool or a set of resource pools for the wireless communication based at least in part on the selected reference signal configuration, at least one of the resource pool or the set of resource pools corresponding to one or more of a demodulation reference signal pattern or a set of demodulation reference signal patterns, a sidelink shared channel allocation, a set of sidelink shared channel allocations, a sidelink phase tracking reference signal configuration, or a set of sidelink phase tracking reference signal configurations, wherein, to transmit the feedback, the one or more processors are individually or collectively operable to execute the code to cause the first apparatus to:
transmit, to the second apparatus, an indication of at least one of the resource pool or the set of resource pools for the wireless communication.

24. (canceled)

25. (canceled)

26. The first apparatus of claim 18, wherein the one or more processors are individually or collectively further operable to execute the code to cause the first apparatus to:
receive, from the second apparatus, a control message comprising an indication to transmit the feedback indicating the selected reference signal configuration, the control message comprising a sidelink control information message, wherein, to transmit the feedback indicating the selected reference signal configuration, the one or more processors are individually or collectively further operable to execute the code based at least in part on the received control message.

27. The first apparatus of claim 18, wherein, to receive the set of transmissions, the one or more processors are individually or collectively operable to execute the code to cause the first apparatus to:
receive, from the second apparatus, one or more downlink transmissions over a downlink shared channel,
wherein the one or more processors are individually or collectively further operable to execute the code to cause the first apparatus to:
estimate at least one of the Doppler spread or the delay spread based at least in part on the received one or more downlink transmissions over the downlink shared channel,
wherein, to select the reference signal configuration from the plurality of reference signal configurations, the one or more processors are individually or collectively further operable to execute the code based at least in part on the estimation of at least one of the Doppler spread or the delay spread, the selected reference signal configuration indicating one or more of a reference signal type, a reference signal pattern, a set of antenna ports, or a reference signal satisfying a criterion.

28. The first apparatus of claim 18, wherein the one or more processors are individually or collectively further operable to execute the code to cause the first apparatus to:
receive, from the second apparatus, a grant comprising a resource allocation based at least in part on transmission of a scheduling request for the resource allocation to transmit the feedback indicating the selected reference signal configuration; and
determine one or more resources to transmit the feedback indicating the selected reference signal configuration based at least in part on the resource allocation,
wherein, to transmit the feedback, the one or more processors are individually or collectively operable to execute the code to cause the first apparatus to:
transmit, to the second apparatus, the feedback indicating the selected reference signal configuration using the one or more resources.

29. (canceled)

30. A non-transitory computer-readable medium storing code for wireless communication at a first device, the code comprising instructions executable by a processor to:
receive, from a second device, a set of transmissions over a shared channel;
determine at least one of a Doppler spread or a delay spread based at least in part on the received set of transmissions over the shared channel;
select a reference signal configuration from a plurality of reference signal configurations based at least in part on the determination of at least one of the Doppler spread or the delay spread; and
transmit, to the second device, feedback indicating the selected reference signal configuration for a subsequent set of transmissions over the shared channel.
